(19) United States
(12) Patent Application Publication
(10) Pub. No.: US 2016/0260095 A1
(43) Pub. Date: Sep. 8, 2016

(54) Containerized Computational Task Execution Management Using a Secure Distributed Transaction Ledger

(71) Applicant: Dell Products, LP, Round Rock, TX (US)

(72) Inventor: Daniel A. Ford, Mount Kisco, NY (US)

(21) Appl. No.: 14/635,577

(22) Filed: Mar. 2, 2015

(51) Int. Cl. G06Q 20/40; G06F 9/445

(52) U.S. Cl. CPC G06Q 20/401; G06F 9/445

(57) ABSTRACT

A peer-to-peer network includes a cryptocurrency system with a block chain, a client system coupled to the cryptocurrency system, and a host system coupled to the cryptocurrency system. The client system publishes a container execution request that includes information associating the client system with a containerized computational task, the cryptocurrency system incorporates the container execution request into a block chain of a cryptocurrency system, and the host system receives the container execution request via the block chain, retrieves the containerized computational task, and executes the containerized computational task.

### FIELD OF THE DISCLOSURE

This disclosure generally relates to information handling systems, and more particularly relates to providing containerized computational task execution management using a secure distributed transaction ledger.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram illustrating a peer-to-peer network according to an embodiment of the present disclosure;

FIG. 2 illustrates a block of block chain according to an embodiment of the present disclosure;

FIG. 3 is a block diagram of container execution request messages according to various embodiments of the present disclosure;

FIG. 4 is a flowchart illustrating a method for containerized computational task execution management using a secure distributed transaction ledger according to an embodiment of the present disclosure; and

FIG. 5 is a block diagram illustrating a generalized information handling system according to an embodiment of the present disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

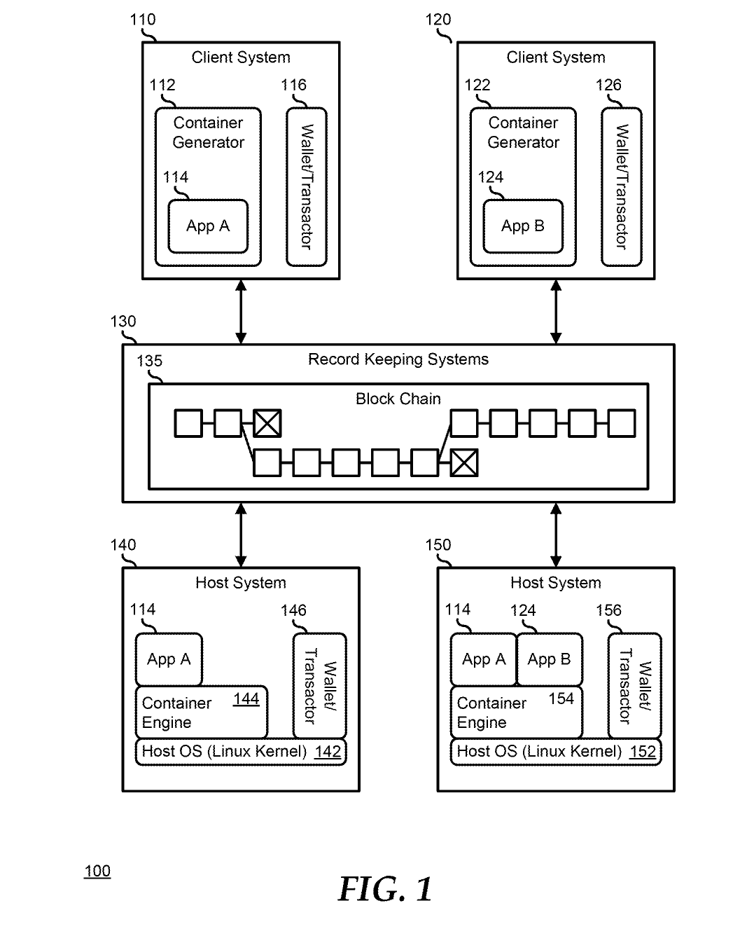

FIG. 1 illustrates an embodiment of a peer-to-peer network 100, which can be implemented by one or more information handling system. For purpose of this disclosure an information handling system includes any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system can be a personal computer, a laptop computer, a smart phone, a tablet device or other consumer electronic device, a network server, a network storage device, a switch router or other network communication device, or any other suitable device and may vary in size, shape, performance, functionality, and price. Further, an information handling system can include processing resources for executing machine-executable code, such as a central processing unit (CPU), a programmable logic array (PLA), an embedded device such as a System-on-a-Chip (SoC), or other control logic hardware. An information handling system can also include one or more computer-readable medium for storing machine-executable code, such as software or data. Additional components of an information handling system can include one or more storage devices that can store machine-executable code, one or more communications ports for communicating with external devices, and various input and output (I/O) devices, such as a keyboard, a mouse, and a video display. An information handling system can also include one or more buses operable to transmit information between the various hardware components.

Peer-to-peer network 100 represents a computing environment for operating a cryptocurrency based currency and messaging exchange to create a decentralized framework for distributing containerized computational tasks from one or more client systems to a set of unknown host systems. A cryptocurrency is a virtual currency that utilizes cryptographic methods to maintain and operate payment transactions securely and transparently. For the purpose of the present disclosure, the cryptocurrency includes not only payment transactions, but also other messaging capabilities, as described further below. An example of a cryptocurrency can include a cryptocurrency such as Bitcoin, Linkcoin, Ripple, NXT, or other cryptocurrencies, with messaging extensions added thereto, and can include a cryptocurrency with native messaging capabilities, such as the Ethereum platform.

A containerized computational task, referred to hereinafter as a task, is a compute task that is packaged in a manner that facilitates the distribution, installation, and execution of the code to perform the task on a wide variety of host systems. As such, a container can include executable code, data, and a list of dependencies and configuration requirements that are required to run the executable code on the data. An example of a task environment includes the Docker containerization technology that permits the distribution, installation, and execution of containerized tasks on suitable Linux platforms (i.e., kernel version 3.8 or later). In a particular embodiment, a container is stored by a client system in a repository and retrieved by a host system from the repository by reference to a container identifier that is associated with the container. For example, in the Docker containerization technology, a unique hash value of the contents of the container serves as the container identifier. Here, for example, the client system can use known methods for downloading the container from the repository, such as via an FTP site associated with the client system, or, where the repository is a distributed repository, via a torrent engine on a peer-to-peer network. In another embodiment, a container is provided directly from a client system to a host system. Once the client system retrieves the container, the task is executed on the host system in isolation from other resources of the host system.

To distribute a task from a client system to an unknown host system, the client system posts a container execution request message to the cryptocurrency system via a secure distributed transaction ledger of the cryptocurrency system. The container execution request message includes a container execution request that is broadcast on the cryptocurrency system through the secure distributed transaction ledger, and that is subsequently discovered by available host systems that may be able to perform the task. In this way, a discovery process between previously unacquainted systems is established that is difficult to corrupt.

A secure distributed transaction ledger is a distributed data structure that is maintained by a group of record keeping systems on the peer-to-peer network of the cryptocurrency system that are typically unaffiliated with each other or with any centralized resource of the cryptocurrency system, and that use cryptographic algorithms and methods to ensure that the state of the secure distributed transaction ledger is valid and reflects a state that is endorsed by a majority of the record keeping systems. An example of record keeping systems includes various cryptocurrency mining and assurance schemes, and the like. A secure distributed transaction ledger will be represented hereafter by a block chain that includes blocks with data regarding recent payment transactions and messages, linking data to a previous block in the block chain, and proof-of-work data the ensure that the state of the block chain is valid and is endorsed by the majority of the record keeping systems. The details of maintaining and assuring the state of a secure distributed transaction ledger are known in the art and are beyond the scope of the present disclosure, and will be discussed no further, except as needed to further the present disclosure.

Peer-to-peer network 100 includes client systems 110 and 120, one or more record keeping systems 130, and host systems 140 and 150. Client system 110 includes a container generator 112 that generates a container for an application 114, and a cryptocurrency system transactor 116, typically referred to as a wallet. Client system 120 similarly includes a container generator 122 that generates a container for an application 124, and a cryptocurrency system transactor 126. Record keeping systems 130 include a block chain 135 and operate to record payment transactions and messages into blocks of the block chain. Host system 140 includes a host operating system 142 that supports containerized processing via a container engine 144, and a transactor 146. Host system 150 similarly includes a host operating system 152 that supports containerized processing via a container engine 154, and a transactor 156.

When client systems 110 and 120 want applications 114 and 124 to be executed on host systems that supports containerized processing, the client systems each publish a container execution request message on peer-to-peer network 100 via respective transactors 116 and 126. Each of record keeping systems 130 operates to receive the container execution request messages, to bundle the container execution request massage with other recently published payment transactions and messages into a new block of block chain 125, and to execute a validation algorithm on the new block to determine which of the record keeping systems' new blocks is deemed the winning block that is appended to the block chain. In this way, every published container execution request is permanently recorded in block chain 135.

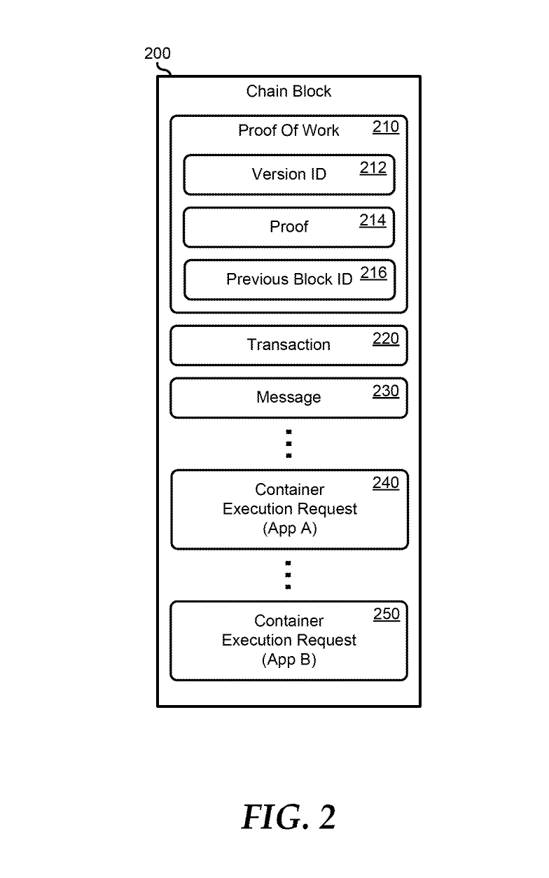

FIG. 2 illustrates a block 200 of block chain 125, that includes proof-of-work information 210, a payment transaction 220, an unrelated message 230, a container execution request message 240 associated with client system 110 and application 114, and a container execution request message 250 associated with client system 120 and application 124. Block 200 can include additional payment transactions, messages, and container execution request messages, or can include fewer payment transactions, messages, and container execution request messages, as needed or desired.

As members of peer-to-peer network 100, host systems 140 and 150 receive the container execution requests from client systems 110 and 120, either directly when the container execution requests are published to the peer-to-peer network by the client systems, or by retrieving container execution request messages 240 and 250 from block chain 135. Host systems 140 and 150 operate to examine the container execution requests and determine if they want to execute the associated tasks, and if so, to receive the associated container and execute the task. In the example illustrated in FIG. 1, host system 140 has received and is executing application 114, and host system 150 has received and is executing applications 114 and 124. Here, for example, application 114 may be a repetitive task that is executable on a more generalized computing environment, and is therefore executable on both host systems 140 and 150, while application 124 may require more specialized computing capabilities that are not found on host system 140. In another example, host system 150 may have greater computing capacity, or may be less heavily burdened with other processing tasks than host system 140, and can therefore execute both applications 114 and 124.

Host systems 140 and 150 use various factors in determining if they want to execute the associated tasks. In a particular embodiment, a host system accesses a reputation service to determine if the requesting client system is a trusted client system, for example by determining that the client system pays its bills or uses containers to run malicious code, or to determine if the container execution request is a trusted request, for example by determining that the container is known to include malicious code. In another embodiment, a host system evaluates the dependencies and configuration requirements associated with the task to determine if the host system can actually perform the requested task. In yet another embodiment, a host system evaluates economic incentives associated with the container execution request, such as a promised payment for completion of the task.

In another embodiment, a host system presumptively accepts a container execution request from one or more particular client systems. For example, a particular device manufacturer can provide specialized host system devices, such as various articles of the Internet-of-Things (IoT) like smart thermostats, that are characterized by the deployment of a System-on-a-Chip (SoC), and that may have far more computing power than is necessary to perform all of the functions of the smart thermostat. Here, the manufacturer may not know the details as to where and how the smart thermostats are distributed, or how they are connected peer-to-peer network 100. In this example, the smart thermostats can be configured to look for container execution requests from a particular client system that is associated with the manufacturer. In this way, the manufacturer can coordinate the smart thermostats to provide regional climate data or other information of interest to the manufacturer, or to push system updates to the smart thermostats. In a particular embodiment, the manufacturer can configure the container to provide geographic information on the distribution of the smart thermostats in order to derive a map of the actual distribution of the smart thermostats. In another example, the manufacturer can have an agreement with another entity to perform various processing tasks with unused computing capacity of the smart thermostats. Here, for example, the particular client identification can be associated with the other entity. In this way, the other entity can have computational work done cheaply, such as where large quantities of data are needed to be processed, but where the timeframe for the processing is less important. An example could include the evaluation of large quantities of scientific data, such as astronomical surveys, genetic information, and the like.

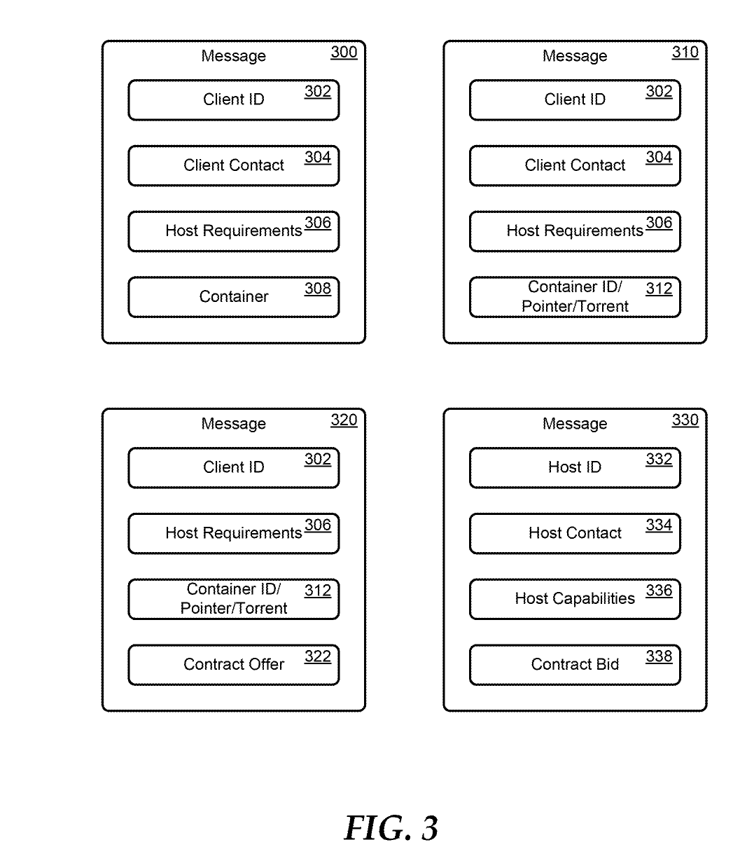

FIG. 3 illustrates various embodiments of container execution request messages 300, 310, and 320 similar to container execution request messages 240 and 250, and a host system container request 330, described below. Container execution request message 300 represents a simplified message that includes client identification information 302, client contact information 304, host requirement information 306, and a container 308. Client identification information 302 can include a unique identifier of the client system that is making the container execution request. Client contact information 304 represents a pointer to a direct communication channel with the client system, such as a URL, an e-mail address, or another pointer that permits the client system and the host system to negotiate the terms of execution of the container directly. Container 308 represents an actual container with the executable and the dependencies and requirements included. In this way, when a host system decides to grant the container execution request, the container execution request is self executable, in that no further information is needed to execute the container execution request. Container execution request message 300 is suitable for simple processing tasks, in terms of code length. However, unless the contents of the container are small, this example can lead to a large increase in the size of block chain 135 if many large containers are required to stored therein.

Container execution request message 310 is similar to container execution request message 300, and includes client identification information 302, client contact information 304, host requirement information 306, and container information 312. Container information 312 represents a pointer to a container. The pointer can include a unique container identifier that is recognized by a particular containerized computational task environment, a pointer to a location to download the container, such as a URL, an FTP server, or the like, a torrent file for peer-to-peer downloading of the container, or another type of pointer, as needed or desired. In this example, when a host system decides to grant the container execution request, the host system accesses container information 312 and downloads the associated container for execution by the host system. This type of container execution request message mitigates the potential increase in the size of block chain 135 that may result from container execution request message 300.

Container execution request message 320 is similar to container execution request message 310, and includes client identification information 302, host requirement information 306, container information 312, and contract offer information 322. Contract offer information 322 operates to communicate an offer by the client system to pay an accepting host system for executing the task. In a particular embodiment, contract offer information 322 includes an offer to pay a fixed sum of currency for the performance of the task. In another embodiment, contract offer information 322 includes an offer to pay a varying sum of currency for the performance of the task based upon some metric associated with the performance of the task. For example, the metric can include a varying sum of currency based upon an amount of time required for the performance of the task, based upon a percent completion of the task in a given amount of time, based upon a precision of the performance of the task, based on a statistical certainty of an outcome of the task, based on another metric associated with the task, or a combination thereof.

Contract offer information 322 can represent an offer that is expressed in terms of a real world currency, or in terms of a virtual currency associated with a cryptocurrency system. Where the real world currency is the basis for contract offer information 322, container execution request message 320 can include client contact information 304, such that the host system can contact the client system to verify the completion of the task and to collect on the offer, and the client system and the host system can engage in a transfer of funds according to methods known in the art. Where the virtual currency is the basis for the contract offer, the cryptocurrency system can ensure the payment based upon cryptocurrency payment transactions as are known in the art. Here, the host system can provide a proof of work for the completion of the task that is signed and verifiable, and the client system can automatically issues a payment transaction to the cryptocurrency system that includes the proof of work and that draws the specified sum from the client system. In another embodiment, the host system submits a message to the cryptocurrency system indicating that the task has been completed, and the client system issues the payment transaction. In another embodiment, contract information 322 can include an invitation to enter into a negotiation between the client system and the host system to determine the sum of currency that will be paid for the completion of the task. Here, the negotiation can be performed on a peer-to-peer basis between the client system and the host system, or can be performed via messages published on peer-to-peer network 100 and memorialized via block chain 135.

Host system container request 330 represents a message published on peer-to-peer network 100 and memorialized via block chain 135, where a host system is advertising its availability to execute one or more tasks. Host system container request 330 represents a simplified message that includes host identification information 332, host contact information 334, host capabilities information 336, and contract bid information 338. Host identification information 332 can include a unique identifier of the host system that is making the container request. Host contact information 334 represents a pointer to a direct communication channel with the host that permits a client system and the host system to negotiate the terms of execution of a container directly. Contract bid information 338 is similar to contract bid information 322 and can represent an offer that is expressed in terms of a real world currency, or in terms of the virtual currency associated with the cryptocurrency system. Here, a client system can search block chain 135 for messages that indicate the availability of advertising host systems for executing tasks.

In a particular embodiment, a host system downloads the container directly upon receiving a container execution request message, and immediately begins executing the task without further communication to the client system. Here, it may be expected that more than one host system also attempts to download the container. In this case, the client system can either deny the download attempt by any subsequent host systems, thereby ensuring that only one host system is executing the task, or the client system can allow subsequent downloads, thereby ensuring that multiple host systems are executing the task. Where multiple host systems are executing the task, the client system can provide different computational data to each subsequent host system, such as where the execution of a task is needed to be performed on a large data set, or the client system can provide the same computational data to each subsequent host system, but can also publish an added bonus amount of currency to the first host system to execute the task.

In a particular embodiment, once a host system has begun to execute a task, the associated client system communicates further with the host system, either via a side-band communication, or via the block chain, to further exert control over the operation of the task on the host system. For example, the client system can provide an indication to the host system to halt, abort, or restart the task, can provided updated data or code for executing the task, or to otherwise control and monitor the execution of the task by the host system. Likewise the host system can communicate with the client system to provided execution updates, to indicate that the execution of the task has been modified by the host system, or to provide other information to the client system, as needed or desired.

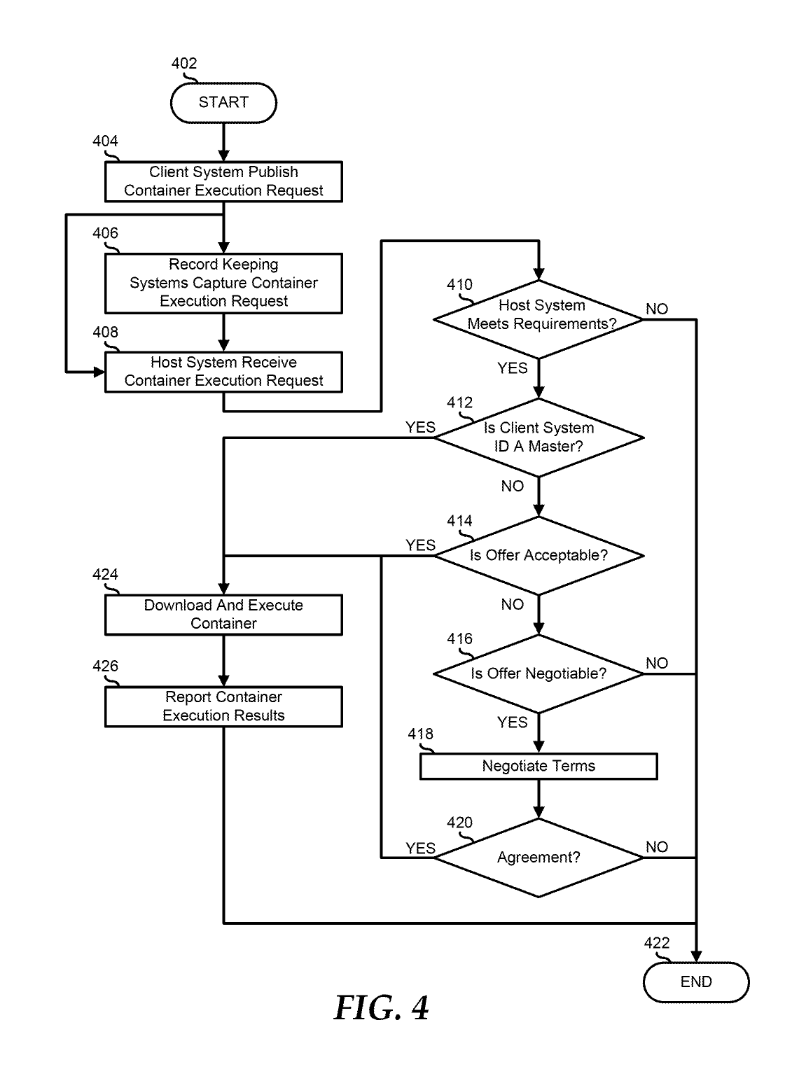

FIG. 4 illustrates a method for containerized computational task execution management using a secure distributed transaction ledger beginning at block 402. A client system publishes a container execution request in block 404. For example, client system 110 can publish a container execution request, similar to one of container execution request messages 310, 320, and 330, on peer-to-peer network 100. Here, the method can take one of two branches to provide the container execution request to a host system in block 408. In a first branch, the host system receives the container execution request directly from the peer-to-peer network. In a second branch, the container execution request is provided to a group of record keeping systems to capture the container execution request as a container execution request message in a block chain, as illustrated in block 406. For example, a container execution request can be provided to record keeping systems 130 for incorporations as a container execution request message in a block of block chain 135. In either case, the host system receives the container execution request in block 408.

After receiving the container execution request, the host system makes a decision as to whether or not the host system meets the dependencies and requirements that are needed to execute the containerized computational task associated with the container execution task request in decision block 410. For example, host system 140 may determine that, being utilized to execute application 114, the host system does not have enough additional computing resources to also execute application 124. If the host system does not meet the dependencies and requirements, the “NO” branch of decision block 410 is taken and the method ends in block 422. If the host system does meet the dependencies and requirements, the “YES” branch of decision block 410 is taken and a decision is made as to whether or not the client system publishing the container execution request is a master client system to the host system in block 412. For example, host system 150 can be configured to receive any and all container execution requests from client system 120.

If the client system is not a master client system to the host system, the “YES” branch of decision block 412 is taken, and a decision is made as to whether or not a contract offer included in the container execution request is acceptable to the host system in decision block 414. For example, container execution request message 320 can include contract offer information 322, and a host system can determine if the offer is sufficient to entice the host system to agree to execute the task associated with the container execution request. If either the client system is a master client system to the host system and the “YES” branch of decision block 412 is taken, or the contract offer included in the container execution request is acceptable to the host system and the “YES” branch of decision block 414 is taken, then the method proceeds to block 424 where the container is downloaded and executed by the host system, the method proceeds to block 426 where a report of the results of the execution of the task is provided from the host system to the client system, and the method ends in block 422.

Returning to decision block 414, if the contract offer included in the container execution request is not acceptable to the host system, the “NO” branch is taken, and a decision is made as to whether or not the terms of the contract offer are negotiable in decision block 416. For example, the container execution request may include an indication that the request is negotiable. If not, the “NO” branch of decision block 416 is taken and the method ends in block 422. If the terms of the contract offer are negotiable, the “YES” branch of decision block 416 is taken and the terms of the contract for execution of the task are negotiated in block 418. A decision is made as to whether or not an agreement is reached in the negotiation in decision block 420. If so, the “YES” branch of decision block 420 is taken and the method proceeds to block 424 where the container is downloaded and executed by the host system. If an agreement is not reached in the negotiation, the “NO” branch of decision block 420 is taken and the method ends in block 422.

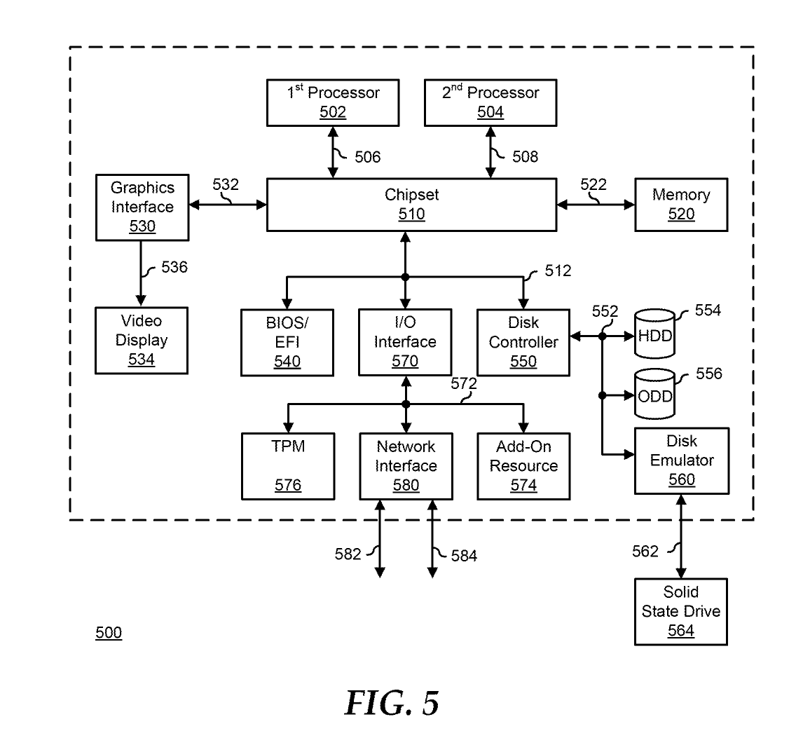

FIG. 5 illustrates a generalized embodiment of information handling system 500. For purpose of this disclosure information handling system 500 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 500 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 500 can include processing resources for executing machine-executable code, such as a central processing unit (CPU), a programmable logic array (PLA), an embedded device such as a System-on-a-Chip (SoC), or other control logic hardware. Information handling system 500 can also include one or more computer-readable medium for storing machine-executable code, such as software or data. Additional components of information handling system 500 can include one or more storage devices that can store machine-executable code, one or more communications ports for communicating with external devices, and various input and output (I/O) devices, such as a keyboard, a mouse, and a video display. Information handling system 500 can also include one or more buses operable to transmit information between the various hardware components.

Information handling system 500 can include devices or modules that embody one or more of the devices or modules described above, and operates to perform one or more of the methods described above. Information handling system 500 includes a processors 502 and 504, a chipset 510, a memory 520, a graphics interface 530, include a basic input and output system/extensible firmware interface (BIOS/EFI) module 540, a disk controller 550, a disk emulator 560, an input/output (I/O) interface 570, and a network interface 580. Processor 502 is connected to chipset 510 via processor interface 506, and processor 504 is connected to the chipset via processor interface 508. Memory 520 is connected to chipset 510 via a memory bus 522. Graphics interface 530 is connected to chipset 510 via a graphics interface 532, and provides a video display output 536 to a video display 534. In a particular embodiment, information handling system 500 includes separate memories that are dedicated to each of processors 502 and 504 via separate memory interfaces. An example of memory 520 includes random access memory (RAM) such as static RAM (SRAM), dynamic RAM (DRAM), non-volatile RAM (NV-RAM), or the like, read only memory (ROM), another type of memory, or a combination thereof.

BIOS/EFI module 540, disk controller 550, and I/O interface 570 are connected to chipset 510 via an I/O channel 512. An example of I/O channel 512 includes a Peripheral Component Interconnect (PCI) interface, a PCI-Extended (PCI-X) interface, a high-speed PCI-Express (PCIe) interface, another industry standard or proprietary communication interface, or a combination thereof. Chipset 510 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/EFI module 540 includes BIOS/EFI code operable to detect resources within information handling system 500, to provide drivers for the resources, initialize the resources, and access the resources. BIOS/EFI module 540 includes code that operates to detect resources within information handling system 500, to provide drivers for the resources, to initialize the resources, and to access the resources.

Disk controller 550 includes a disk interface 552 that connects the disc controller to a hard disk drive (HDD) 554, to an optical disk drive (ODD) 556, and to disk emulator 560. An example of disk interface 552 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 560 permits a solid-state drive 564 to be connected to information handling system 500 via an external interface 562. An example of external interface 562 includes a USB interface, an IEEE 1394 (Firewire) interface, a proprietary interface, or a combination thereof. Alternatively, solid-state drive 564 can be disposed within information handling system 500.

I/O interface 570 includes a peripheral interface 572 that connects the I/O interface to an add-on resource 574, to a Trusted Platform Module (TPM) 576, and to network interface 580. Peripheral interface 572 can be the same type of interface as I/O channel 512, or can be a different type of interface. As such, I/O interface 570 extends the capacity of I/O channel 512 when peripheral interface 572 and the I/O channel are of the same type, and the I/O interface translates information from a format suitable to the I/O channel to a format suitable to the peripheral channel 572 when they are of a different type. Add-on resource 574 can include a data storage system, an additional graphics interface, a network interface card (MC), a sound/video processing card, another add-on resource, or a combination thereof. Add-on resource 574 can be on a main circuit board, on separate circuit board or add-in card disposed within information handling system 500, a device that is external to the information handling system, or a combination thereof.

Network interface 580 represents a NIC disposed within information handling system 500, on a main circuit board of the information handling system, integrated onto another component such as chipset 510, in another suitable location, or a combination thereof. Network interface device 580 includes network channels 582 and 584 that provide interfaces to devices that are external to information handling system 500. In a particular embodiment, network channels 582 and 584 are of a different type than peripheral channel 572 and network interface 580 translates information from a format suitable to the peripheral channel to a format suitable to external devices. An example of network channels 582 and 584 includes InfiniBand channels, Fibre Channel channels, Gigabit Ethernet channels, proprietary channel architectures, or a combination thereof. Network channels 582 and 584 can be connected to external network resources (not illustrated). The network resource can include another information handling system, a data storage system, another network, a grid management system, another suitable resource, or a combination thereof.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method comprising:
publishing, by a client system, a container execution request on a peer-to-peer network, wherein the container execution request includes information associating the client system with a containerized computational task;
incorporating the container execution request into a block chain of a cryptocurrency system on the peer-to-peer network;
receiving, at a host system, the container execution request via the block chain;
retrieving, at the host system, the containerized computational task; and
executing, at the host system, the containerized computational task.

2. The method of claim 1, further comprising:
prior to retrieving the containerized computational task, determining, by the host system, to execute the containerized computational task;
wherein retrieving the containerized computational task is in response to determining to execute the containerized computational task.

3. The method of claim 2, wherein in determining to execute the containerized computational task the method further comprises:
determining, by the client system, that the client system meets a requirement, wherein the requirement is included in the container execution request.

4. The method of claim 2, wherein determining to execute the containerized computational task is based upon an identification of the client system.

5. The method of claim 2, wherein determining to execute the containerized computational task is based on a contract offer included in the container execution request.

6. The method of claim 5, further comprising:
receiving, at the client system, an indication that the host system has completed the containerized computational task; and
providing, by the client system, a payment to the host system in response to receiving the indication, wherein the payment is based on the contract offer.

7. The method of claim 6, wherein the payment is made in a cryptocurrency associated with the cryptocurrency system.

8. The method of claim 5, wherein:
the contract offer includes an indication that the contract offer is negotiable; and
the method further comprises:
prior to retrieving the containerized computational task, receiving, at the client system, a counter offer from the host system; and
providing, by the client system, an acceptance of the counter offer to the host system, wherein retrieving the containerized computational task is in response to receiving the acceptance.

9. The method of claim 1, wherein the containerized computational task is included in the container execution request.

10. The method of claim 1, wherein in retrieving the containerized computational task the method further comprises:
determining, by the host system, a location for the containerized computational task from the container execution request;
wherein the containerized computational task is retrieved from the location.

11. A peer-to-peer network comprising:
a cryptocurrency system including a block chain;
a client system coupled to the cryptocurrency system; and
a host system coupled to the cryptocurrency system;
wherein:
the client system publishes a container execution request that includes information associating the client system with a containerized computational task;
the cryptocurrency system incorporates the container execution request into a block chain of a cryptocurrency system; and
the host system receives the container execution request via the block chain, retrieves the containerized computational task, and executes the containerized computational task.

12. The peer-to-peer network of claim 11, wherein:
the host system determines to execute the containerized computational task prior to retrieving the containerized computational task; and
the host system retrieves the containerized computational task in response to determining to execute the containerized computational task.

13. The peer-to-peer network of claim 12, wherein, in determining to execute the containerized computational task the host system further:
determines that the client system meets a requirement, wherein the requirement is included in the container execution request.

14. The peer-to-peer network of claim 12, wherein determining to execute the containerized computational task is based upon an identification of the client system.

15. The peer-to-peer network of claim 12, wherein determining to execute the containerized computational task is based on a contract offer included in the container execution request.

16. The peer-to-peer network of claim 15, wherein the client system further:
receives an indication that the host system has completed the containerized computational task; and
provides a payment to the host system in response to receiving the indication, wherein the payment is based on the contract offer.

17. The peer-to-peer network of claim 16, wherein the payment is made in a cryptocurrency associated with the cryptocurrency system.

18. The peer-to-peer network of claim 15, wherein:
the contract offer includes an indication that the contract offer is negotiable; and
the client system further:
receives a counter offer from the host system prior to the host system retrieving the containerized computational task; and
provides an acceptance of the counter offer to the host system, wherein retrieving the containerized computational task by the host system is in response to receiving the acceptance.

19. The peer-to-peer network of claim 11, wherein the containerized computational task is included in the container execution request.

20. A non-transitory computer-readable medium including code for performing a method, the method comprising:
publishing a container execution request on a peer-to-peer network, wherein the container execution request includes information associating a client system with a containerized computational task;
incorporating the container execution request into a block chain of a cryptocurrency system on the peer-to-peer network;
receiving the container execution request via the block chain;
retrieving the containerized computational task; and
executing the containerized computational task.
